(19) United States
(12) Patent Application Publication
(10) Pub. No.: US 2005/0123355 A1
(43) Pub. Date: Jun. 9, 2005

(54) Method of installing a fibreglass pipeline

(76) Inventors: Gary J. Kolenski, Drayton Valley (CA); Donald S. Coughlin, Buck Creek (CA)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 10/852,066

(22) Filed: May 24, 2004

(30) Foreign Application Priority Data
Dec. 3, 2003 (CA) 2,449,155

(51) Int. Cl. F16L 1/12

(52) U.S. Cl. 405/184.2; 405/170; 405/168.1

(57) ABSTRACT

A method of installing fibreglass pipelines. Pull points are established at spaced intervals along the pipeline. Endless tubing liners are pulled through the pipeline between pull points to bridge a plurality of pipe joints. The endless tubing liners are expanded by gradually increasing pressure to force any fluids in the annulus out of vents. The endless tubing liners prevent leakage through the plurality of pipe joints connecting the sections of fibreglass pipe along the pipeline and the fibreglass pipe provides outer reinforcement for the endless tubing liners, enabling the endless tubing liners to maintain pressure containment.

### FIELD OF THE INVENTION

The present invention relates to a method of installing a fibreglass pipeline.

### BACKGROUND OF THE INVENTION

There are over one million kilometers of fibreglass pipelines in the Province of Alberta that are “shut in” due to an inability to meet pressure standards. Most of these fibreglass pipelines have never been in service. They failed to meet pressure standards from the day they were installed.

SUMMARY OF THE INVENTION

What is required is a method of installing fibreglass pipelines to ensure that pressure standards are met.

According to the present invention there is provided a method of installing fibreglass pipelines. A first step involves connecting a plurality of sections of fibreglass pipe in end to end relation below ground to form a pipeline. A second step involves establishing pull points at spaced intervals along the pipeline, with each interval between pull points encompassing a plurality of pipe joints. A third step involves pulling an endless tubing liner through the pipeline between pull points to bridge the plurality of pipe joints. Each endless tubing liner has an outer diameter which is less than the inner diameter of the fibreglass pipe. A fourth step involves connecting adjacent endless tubing liners and adjacent sections of fibreglass pipe at the pull points. This connection is made using a spool connector having an inner connective liner adapted to connect to adjacent endless tubing liners, opposed end flanges adapted to connect to adjacent sections of fibreglass pipe, and a vent in fluid communication with the annulus between the endless tubing liners and the fibreglass pipe. A fifth step involves expanding the endless tubing liners by gradually increasing pressure to slowly collapse the annulus and force any fluids in the annulus out of the vent. A sixth step involves increasing pressure in the pipeline up to desired operating pressures.

With this method, the endless tubing liners prevent leakage through the plurality of pipe joints connecting the sections of fibreglass pipe along the pipeline and the fibreglass pipe provides outer reinforcement for the endless tubing liners, enabling the endless tubing liners to maintain pressure containment.

### BRIEF DESCRIPTION OF THE DRAWINGS

These and other features of the invention will become more apparent from the following description in which reference is made to the appended drawings, the drawings are for the purpose of illustration only and are not intended to in any way limit the scope of the invention to the particular embodiment or embodiments shown, wherein:

FIG. 1 is a side elevation view, in section, of a pipeline prepared in accordance with the method of installing a fibreglass pipeline;

FIG. 2 is a detailed side elevation view of the pipeline illustrated in FIG. 1;

FIG. 3 is an end elevation view of the pipeline illustrated in FIG. 2, with a liner installed;

FIG. 4 is a side elevation view of the spool connector, connecting the pipeline illustrated in FIG. 2, after burial underground;

FIG. 5 is a partially exploded side elevation view of two spool connectors with a fluid communication conduit bridging fluid flow between.

### DETAILED DESCRIPTION OF THE PREFERRED EMBODIMENT

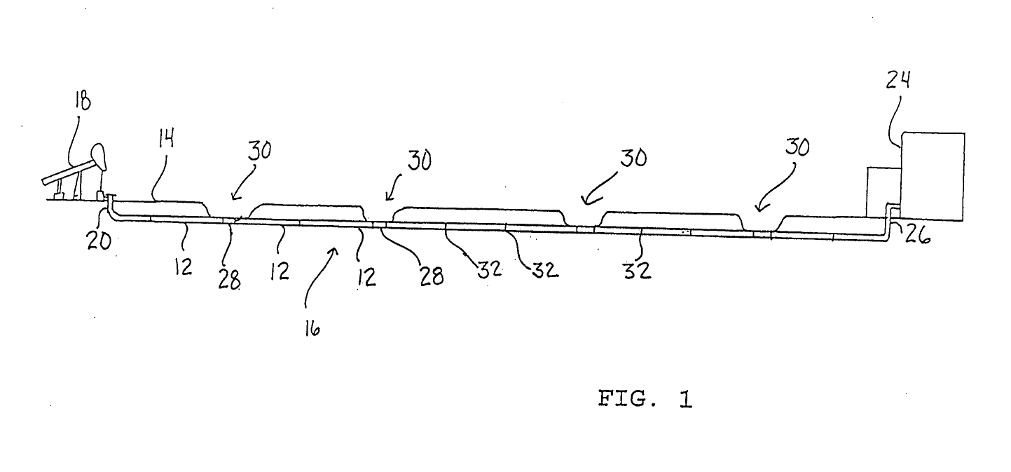

The preferred method of installing a fibreglass pipeline generally will now be described with reference to FIGS. 1 through 5.

Structure and Relationship of Parts:

Referring to FIG. 1, there is illustrated a method of installing fibreglass pipelines, which includes a first step of connecting a plurality of sections of fibreglass pipe 12 in end to end relation below ground 14 to form a pipeline, generally referenced by numeral 16. In the illustrated embodiment, a pumpjack 18 is provided at first end 20 of pipeline 16 and a storage tank 24 is provided at a second end 26.

A second step involves establishing pull points 28 at spaced intervals 30 along pipeline 16 where each interval 30 between pull points 28 encompasses a plurality of pipe joints 32. Ground 14 is excavated at pull points 28 to provide access to pipeline 16 as illustrated in FIG. 1.

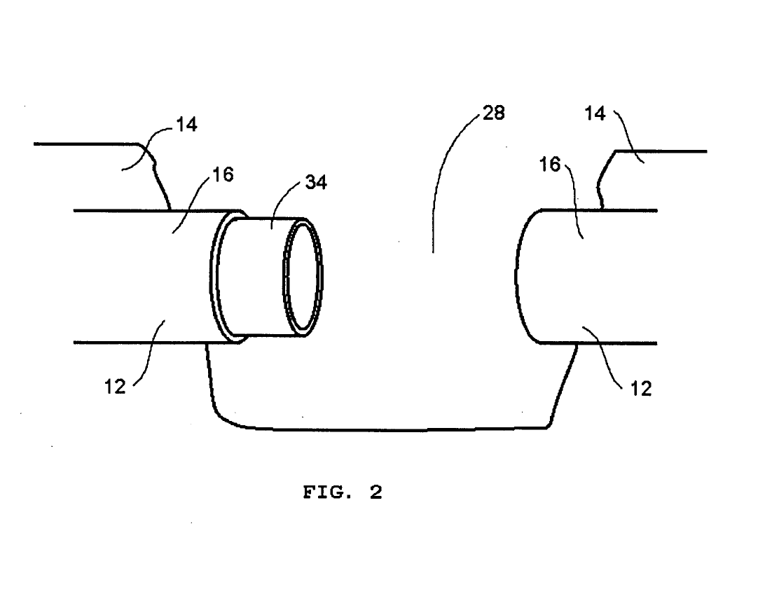

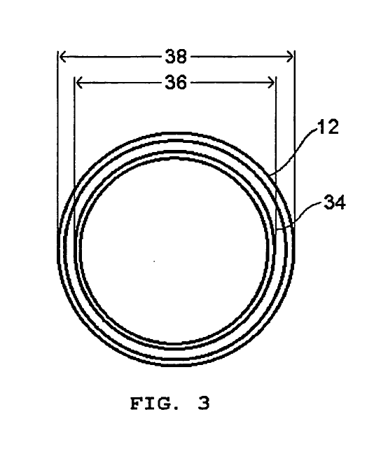

Referring to FIG. 2, a third step involves pulling an endless tubing liner 34 through pipeline 16 between pull points 28 to bridge the plurality of pipe joints 32 illustrated in FIG. 1. Referring to FIG. 3, each endless tubing liner 34 has an outer diameter 36 which is less than an inner diameter 38 of fibreglass pipe 12.

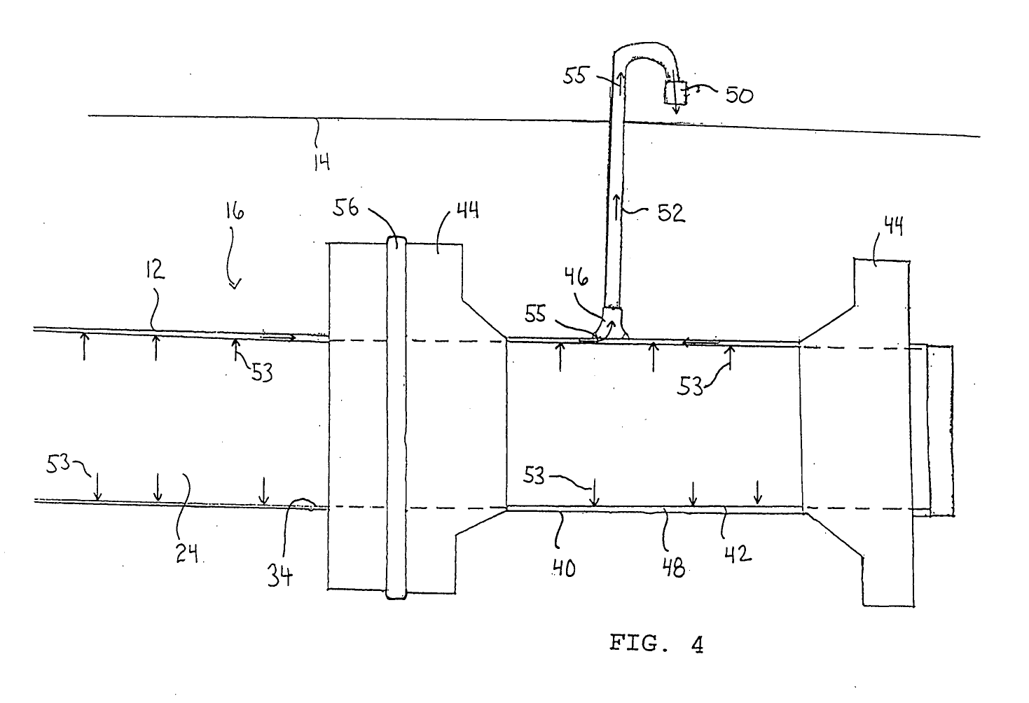

Referring to FIG. 4, a fourth step involves connecting adjacent endless tubing liners 34 and adjacent sections of fibreglass pipe 12 at pull points 28. The connection is made using a spool connector 40 that has an inner connective liner 42 which is adapted to connect to adjacent endless tubing liners 34, opposed end flanges 44 that are adapted to connect to adjacent sections of fibreglass pipe 12, and a vent 46 in fluid communication with annulus 48 between endless tubing liners 34 and fibreglass pipe 12. There is also a neoprene seal 56 between the end flanges 44 and the fibreglass pipe 12. Each vent 46 is closed with a valve 50 to isolate annulus 48. Valve 50 is positioned on an above ground riser 52 that is connected to vent 46. Each above ground riser 52 provides an accessible fluid monitoring location, as will hereinafter be further described.

Referring to FIG. 4, a fifth step involves expanding endless tubing liners 34 by gradually increasing pressure (as indicated by arrows 53) to slowly collapse annulus 48 and force any fluids in annulus 48 out of vent 46 (as indicated by arrows 55). A sixth step involves increasing pressure in pipeline 16 up to desired operating pressures. Referring to FIG. 1, with this method, endless tubing liners 34 will prevent leakage through plurality of pipe joints 32 that connect sections of fibreglass pipe 12 along pipeline 16 and fibreglass pipe 16 provides outer reinforcement for endless tubing liners 34 thereby enabling endless tubing liners 34 to maintain pressure containment.

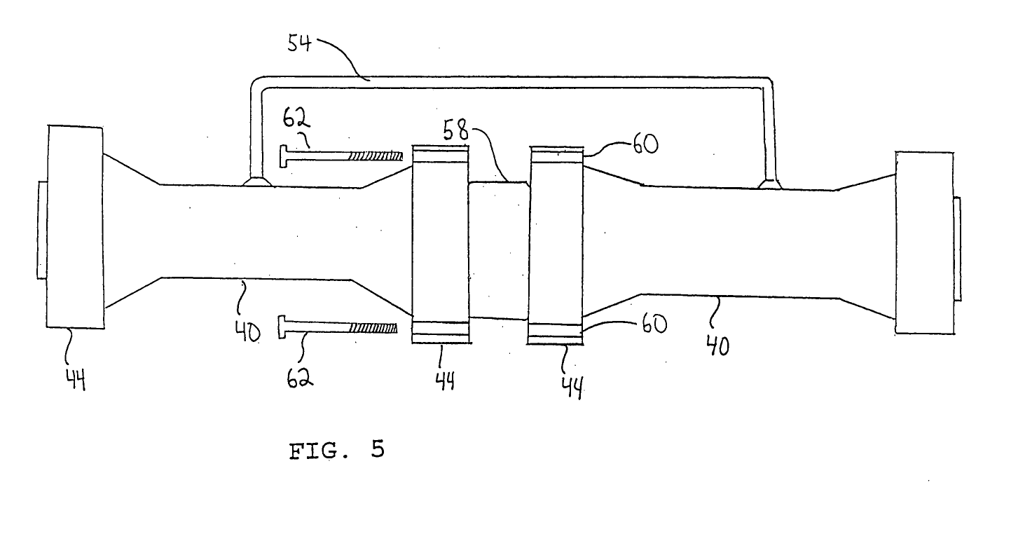

Referring to FIG. 4, after installation each valve 50 is regularly monitored for evidence of fluid flow in annulus 48 which would indicate that the integrity of endless tubing liners 34 has been compromised. Referring to FIG. 5, fluid communication is maintained between annulus 48 across spool connectors 40 by connective conduit 54, thereby reducing the number of fluid monitoring locations required. An expansion ring 58 that is continuous around its perimeter is used to connect the tubing liners 34 to provide a stable joint. The flanges 44 are then tightened together by bolts 62 through bolt holes 60. When the bolts are tightened, expansion ring 58 will not be visible.

Further Information and Cautionary Warnings:

Annular Fluid Inspection Spooling:

Fiberglass flange can be installed by a thread cord, or cut or glued.

A 24 hour test should be performed with the liner installed.

The annular fluid will need longer to bleed off.

Denso paste (Denso is a Trade Mark) and Denso tape on can be used on spool connectors

a rope socket can be put into a medium density foam pig

Please note that lubricant must be used at any time that the wireline's line goes into the pipeline

A test piece of plastic liner should be used to assure condition of the line.

Cleaning runs should be done in the direction of flow. By way of example, cleaning runs should flow into the bell and out of the pin as this will assure the pin isn't taking a direct hit from pigging.

All fittings must be removed and long radius bend has to be installed

Under Cover Sheet

spool pieces installed

fiberglass prep work

20 meter bellholes

10 meter bellholes

All threaded and beveled ends must be cleaned with acid tone, this will help oxidize the fiberglass pipe, so the glue or compound will bond to the fiberglass

If a joint end becomes dirty, it should be wiped off and cleaned before reapplying the glue or compound on the fiberglass pipe to make the connection.

Procedure For Liner Installation in Jointed Fiberglass Pipeline

Jointed fiberglass pipeline is prepared by pigging. A sizing disk can be used to determine if the pipe of host pipeline can accommodate the liner.

If the glue is thick and the internal diameter of the pipeline joint is smaller or if a beaker can round off the heavy glue bead, the joint can be taking down by starting with a sizing disk that is 0.05 smaller than internal diameter of the host pipeline. By way of example, if the line is 2.95, then it is preferable to should start with a disk that is 2.90 and then use gradually larger sizing disk such as 2.91-2.92-2.93-2.94-2.95. A gradual increasing of the opening is preferred, as increasing the opening too quickly results in damage to the beaded joints.

Cleaning of a Pipe Hostline:

When working with flow lines which are still in service, it is preferable to inject a barrel of de-waxing chemical at each well head, and let the flow take it to the system for processing. This will soften waxes and asphaltines.

Reasons for Pull Point Locations.

For pulls that are 2-3″ line pipe, 400 meters of host pipeline are recommended. This results in less stress on the liners pulling point. Flanges are installed at approximately every 400 meters so the drag weight of the liner does not exceed recommended weight levels. The data can be recorded off a wireline and established to company ticket when turned in to consultant weight or field rep as the first 50 meters take too much stress.

The Liner Installation through the Joint

An air test on the hostline after a water flush will tell you if a line has a slow seeper, or fast leak.

As well as buried flanges, G.P.S. all line breaks and repairs.

The joints of the fiberglass pipeline will have to be smooth and not sharp or have a grape. The test piece will tell you the shape the joint is in.

If there is a gouge in the test piece, such as one that is ¼″ wide and 1 mil deep, then that is 20% deep and is a thin and weak spot for a split to occur.

If the test piece has a slightly scratched appearance, then the liner can be pulled. The joints are ready to accommodate liner, and are able to pressured up and not damage liner when liner is expanded to the pipeline wall.

Expanding Liner

When liner is installed and all flanges are bolted up and blinds are positioned on each end, an air test can preformed whereby air is pumped up to 100 lbs. If the pipeline holds the air and no leaks are confirmed.

Hot water expansion will expand the liner without stress and with less chance of a weak or thin spot developing.

Hot water expansion makes the liner more pliable and will fill in the joints, so that all the annular fluids are squeezed out. The liner will not burst, move, or develop a thin spot.

The liner will fill in and stay at any uneven joints by molding to the form of the uneven joints

Fiberglass Flange can be Installed by Threadends or Cuts and Glued

24 Hours test, with liner installed or 8 hours test (with approval of regulatory authorities)

Annular fluid will require a longer bleed off time, with a pressure of no higher than 300 lbs

Tie in source well and oil production flow-lines

Less pipeline going in the ground

This will put the good lines back into use

Spooling 100% x-rayed and test hydrotested in the shop

Denso paste on nuts and Denso tape on spooling

Liner Installation

When last sizer has been used, the pulling head can be 0.295 or −294.

When liner is first put in the flange, lubricant is used on the liner. The liner should be clean and the ground surface should not come into contact with the liner. It is preferred that the liner is hand cleaned with a rag. The liner pipe should also be cleaned before the liner is pulled through the roller box or swedge down for slip liner as it could otherwise pick up a rock or dirt particle resulting in damage. If the pipe on the reels is dirty, it can put all the liner in the line and build up and causing more drag weight on the line. The same problem can also occur with ice and snow.

When liner is coming off the reel, there is no weight and as a result the liner dips into the ditch or before roller box or swedge down. Again, a small rock can be pushed into the plastic at this time, which can start a pin hole.

If the pipe is dirty and there is mud in it, there may be additional mud in the annular. No host pipeline should have any of these obstructions in it's line, or the liner. A quick air test to the liner that is still on a reel will indicate whether there is a leak or not before liner is installed.

For small diameters, if liner is on reels, a smaller amount of land disturbance occurs and there is less damage on land. Any liner or reels will have no weight on the end where liner goes in and the liner droops down. As a result, it can pick up a small stone which might end up in the annular between the plastic and hostpipe and make its way through when line pressure is at the M.O.P. Air squeeze can prevent stones, dirt, snow, and ice from entering the hostline, rolldown or swedge liner size reducer so no rocks or other detrimental materials can enter system.

Liner Installation

The hostline internal dimension is needed to size the liner purchase. For example, if the internal dimension is 0.307—on the hostline, the liner is a tight letting liner. It can be altered to 0.309—to make sure of a tight fit. If the liner is a slip liner type, it is smaller than joint size and internal dimension. An expandable liner that expands to hostline wall with pressure is expandable fitting liner. For low pressure this will give less liner movement. The slip liner can do longer pulls with areas such as ponds, muskeg, river crossings etc. At high pressure the tight or slip liner will do the same job, tight fitting liners will be less chance of a longitudinal split or a blister type bubble, the liner that has a tight fit will expand to the hostline wall and can not stretch and have failure due to over pressure which is too fast, and not letting the air out of the annulus and air can get trapped in the hostline at the joints. When the liner is pressured up, the air gets trapped, and the maximum operating pressure (M.O.P.) is reached. As the weep holes do not have air or fluid coming out, it may appear that the expansion is done and and the pressure is increased to the M.O.P. In this instance, it is preferable to take the liner pressure up to 300 lbs and let the annulus bleed out longer. When line has no more air or fluid coming out, then it is time to take line pressure up to M.O.P. Visually inspect at ⅛″ weep hole at vent riser to make sure that there is no blockage or ice is stopping the weephole or vent from bleeding all the air or fluid before taking line pressure to the M.O.P. It is preferable that hot water (which no more than 60 c) expansion is done with the liner, this will make the liner softer and more pliable to fill in the joints and push out the trapped air and fluid to the weephole (vents). At only 300 lbs the liner will let more of the air and fluid reach the vents and is not as hard. Cold plastic is more likely to not let the air or fluid by cold plastic would not move to let the air or fluid to vents, this is most common on hills or bends, or even heavy beads at joints the lines should bleed off all air and fluid at 60 c and at 300 lbs.

No time limit is required, but enough time is needed to push all of the fluid from the joints and past all the other joints before the liner fills in the joints. When the liner test is done at the M.O.P. the hostline will have a more stable test than moving fluid along the line and filling in the annular space and lowering the test pressure.

Spool Connectors

raised face flanges and schedule pipe with a ½″ 3000 lbs thread-o-let

Aluminum spool connectors can be used as well as stainless steel, but must be made of standard pipeline materials and be 100% radiographed and shop hydrotested. Any acceptable coatings and cathodic materials can be used on this annular fluid inspection device, along with any additional coatings to prevent corrosion

The retainer rings for poly flanges must be supplied by liner company for warranty reasons

The spool piece is only for checking the annulus for a leak in the liner.

The spool piece and flanges must be supported by sandbagging

When bolted on to the fiberglass pipeline flange, a recommended torque by the manufacture of the fiberglass pipeline must be followed to it's specification as applied by the manufacture

Pigs and Procedure for Cleaning

Foam pig=low density, medium density, high density

Polyurethane, Batching (multi disk: if all disks cups are full of pipeline residue, it still needs a cleaning run if only the first 2 or 3 are full and back 2 are empty the line is probably clean and ready for test piece or liner,

Brush pigs should not be used as the wires can fall off. As a result when the liner is pulled, the wire can poke into the liner and act as if they were a porcupine quill and put a pin hole in the liners. Furthermore, the wires end up into the flow and it will be difficult to find evidence of leak reasons. Small rocks that stick to the liner during installation will do the same thing.

Sizing disks that are made of steel are not recommended as they can scar the host fiberglass pipeline. Aluminum disks or reamers can be used to open heavily glued joints which can be rounded off to no more than 0.005 for example; 290 if liner size is 0.295 of hostpipe size and wall thickness, all sizes must be done from −290, to 291 and 292, then 0.293, 0.294, and 0.295 liner size is complete

Please note that lubricant should be used on each pig run.

Less prep is required on joint size. Internal dimensions can be reamed out with a reamer. Please note that after the reaming is completed, its very important to pig out any remnants left by the reamers. A test piece will indicate what the joints are like. For example, a joint that cuts the liner can be rounded off, or a cut out can be performed cut and glue new 4′ pup, to repair bad join on host pipe. Another pigging request on procedure can be more complete at a later date.

Installing Fiberglass Flange

Apply using the fiberglass pipeline manufacture's procedure manual for the hostline being lined. Once fiberglass flanges are installed, then the tile pigging can be done. A slick line can be attached to a foam, medium density pig which will not harm fiberglass joints. The pig is launched down and then pulled back the host line, wireline and rope socket. Once cleaning runs are complete and sizers have been run, a test piece of plastic with plastic pulling head can be pulled through to check for scaring depth to make sure that it can accommodate liner and wireline weight through the joints. Air test the host line at 100 lbs. It is also important to check weep holes to make sure liner has no leaks, before the hydrotest.

When a pipeline has been cleaned and seems ready for liner, pull a test piece of line about 7 meters long. After pulling, a visual inspection will indicate if the host pipe will scar the plastic and the weight it took to pull through a joint.

Operation During Winter:

In winter, lubricants like Canola oil can gel and glop together due to cold temperatures and therefore do not operate as good lubricants for winter. A lubricant that is suitable for fiberoptic installations, such as polywater is preferable.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent to one skilled in the art that modifications may be made to the illustrated embodiment without departing from the spirit and scope of the invention as hereinafter defined in the Claims.

1. A method of installing fibreglass pipelines, comprising the steps of:
connecting a plurality of sections of fibreglass pipe in end to end relation below ground to form a pipeline;
establishing pull points at spaced intervals along the pipeline, each interval between pull points encompassing a plurality of pipe joints;
pulling an endless tubing liner through the pipeline between pull points to bridge the plurality of pipe joints, each endless tubing liner having an outer diameter which is less than the inner diameter of the fibreglass pipe;
connecting adjacent endless tubing liners and adjacent sections of fibreglass pipe at the pull points using a spool connector having an inner connective liner adapted to connect to adjacent endless tubing liners, opposed end flanges adapted to connect to adjacent sections of fibreglass pipe, and a vent in fluid communication with the annulus between the endless tubing liners and the fibreglass pipe;
expanding the endless tubing liners by gradually increasing pressure to slowly expand the liners and collapse the annulus, forcing any fluids in the annulus out of the vent; and
increasing pressure in the pipeline up to desired operating pressures, the endless tubing liners preventing leakage through the plurality of pipe joints connecting the sections of fibreglass pipe along the pipeline and the fibreglass pipe providing outer reinforcement for the endless tubing liners enabling the endless tubing liners to maintain pressure containment.

2. The method as defined in claim 1, further including the step of closing each vent to isolate the annulus.

3. The method as defined in claim 2, at least one of the vents being closed with a valve.

4. The method as defined in claim 3, further including the step of monitoring the valve for fluid flow in the annulus indicative that the integrity of the endless tubing liners have been compromised.

5. The method as defined in claim 3, the valve being positioned on an above ground riser connected to the vent.

6. The method as defined in claim 4, further including the step of maintaining fluid communication between the annulus across spool connectors, thereby reducing the number of fluid monitoring locations required.
